(19) United States
(12) Patent Application Publication
(10) Pub. No.: US 2023/0156506 A1
(43) Pub. Date: May 18, 2023

(54) Communication Apparatus and Method for Handling a Measurement Configuration

(71) Applicant: MEDIATEK INC., Hsin-chu (TW)

(72) Inventors: Wei-Jen Chen, Hsinchu City (TW); Chun-Fan Tsai, Hsinchu City (TW); Jiaxian Pan, Hsinchu City (TW); Wei-Jen Chen, Hsinchu City (TW)

(73) Assignee: MEDIATEK INC., Hsin-Chu (TW)

(21) Appl. No.: 17/970,515

(22) Filed: Oct. 20, 2022

Related U.S. Application Data
(60) Provisional application No. 63/279,210, filed on Nov. 15, 2021.
(60) Provisional application No. 63/332,743, filed on Apr. 20, 2022.

(51) Int. Cl. H04W 24/10

(52) U.S. Cl. CPC H04W 24/10

(57) ABSTRACT

A method for handling a measurement configuration including: determining a measurement configuration, wherein the measurement configuration includes a measurement object and a plurality of reporting configurations; performing at least one first measurement for the measurement object, to generate at least one first measurement result; and transmitting the at least one first measurement result to a network device according to a reporting configuration of the plurality of reporting configurations in response to the reporting configuration being satisfied; wherein the plurality of reporting configurations correspond to the measurement object.

### CROSS REFERENCE TO RELATED APPLICATIONS

This application claims the benefit of U.S. Provisional Application No. 63/279,210, filed on Nov. 15, 2021. Further, this application claims the benefit of U.S. Provisional Application No. 63/332,743, filed on Apr. 20, 2022. The contents of these applications are incorporated herein by reference.

### BACKGROUND

In the 3rd Generation Partnership Project (3GPP) standard, a measurement mechanism performed by the user equipments (UEs) is predefined. The network configures the measurement configuration to the UEs, and the UEs perform the measurements and transmit the measurement results according to the measurement configuration. However, the measurement configuration is not necessarily suitable for all UEs. The performances of performing the measurement and transmitting the measurement result may be reduced. For example, a delay in transmitting the measurement result may occur due to the UE with an improper measurement configuration.

### SUMMARY

It is an objective of the invention to provide a communication apparatus, in order to solve the above problem.

An embodiment of the invention provides a method for handling a measurement configuration comprising: determining a measurement configuration, wherein the measurement configuration comprises a measurement object and a plurality of reporting configurations; performing at least one first measurement for the measurement object, to generate at least one first measurement result; and transmitting the at least one first measurement result to a network device according to a reporting configuration of the plurality of reporting configurations in response to the reporting configuration being satisfied; wherein that the plurality of reporting configurations correspond to the measurement object.

An embodiment of the invention provides a communication apparatus comprising a radio transceiver and a processing circuit. The radio transceiver is configured to transmit or receive wireless signals. The processing circuit is coupled to the radio transceiver and configured to perform operations comprising: determining a measurement configuration, wherein the measurement configuration comprises a measurement object and a plurality of reporting configurations; performing at least one measurement for the measurement object, to generate at least one measurement result; and transmitting the at least one measurement result to a network device according to a reporting configuration of the plurality of reporting configurations in response to the reporting configuration being satisfied; wherein the plurality of reporting configurations correspond to the measurement object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of a communication apparatus according to an embodiment of the invention.

FIG. 2 is an exemplary block diagram of a processing device according to an embodiment of the invention.

FIG. 3 is a flowchart of a process according to an embodiment of the invention.

FIG. 4 is a schematic diagram of a scenario according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

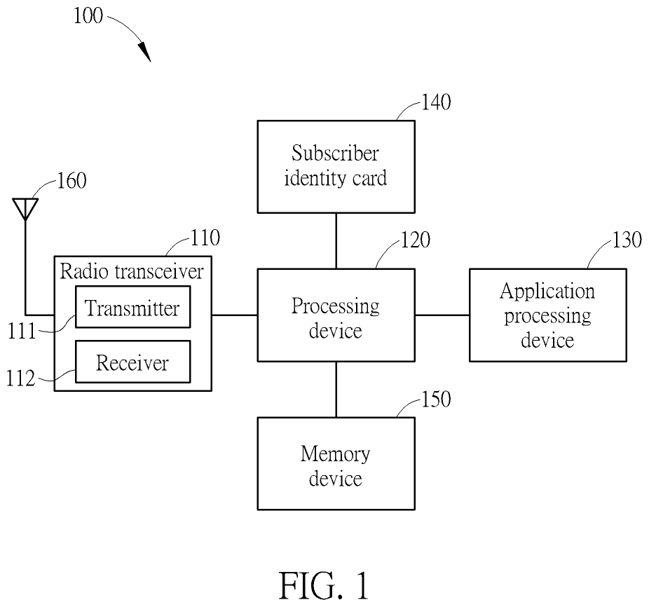

FIG. 1 is an exemplary block diagram of a communication apparatus 100 according to an embodiment of the invention. The communication apparatus 100 may be a portable electronic device, such as a Mobile Station (MS), which may be interchangeably referred to as User Equipment (UE). The communication apparatus 100 may comprise a radio transceiver 110, a processing device 120, an application processing device 130, a subscriber identity card 140, a memory device 150 and at least one antenna 160. The radio transceiver 110 may be configured to transmit and/or receive wireless signals to and/or from a network device (not shown) via the antenna(s) 160, so as to communicate with the network device via a communication link established between the communication apparatus 100 and the network device. The radio transceiver 110 may comprise a receiver 112 configured to receive wireless signals and a transmitter 111 configured to transmit wireless signals. The radio transceiver 110 may be further configured to perform radio frequency (RF) signal processing. For example, the receiver 112 may convert the received signals into intermediate frequency (IF) or baseband signals to be processed, or the transmitter 111 may receive the IF or baseband signals from the processing device 120 and convert the received signals into wireless signals to be transmitted to the network device in the wireless network or in an access network (e.g., a terrestrial network (TN), a non-terrestrial network (NTN), a wireless local area network (WLAN), a personal area network (PAN) or a wireless local access network). According to an embodiment of the invention, the network device may be a cell, a Node-B (NB), an evolved Node-B (eNB), a g Node-B (gNB), a base station, a Mobility Management Entity (MME), an Access and Mobility Management Function (AMF) device, etc., at the network side and communicating with the communication apparatus 100 by the wireless signals via the communication link.

The transmitter 111 and the receiver 112 of the radio transceiver 110 may comprise a plurality of hardware devices to perform RF conversion and RF signal processing. For example, the transmitter 111 and/or the receiver 112 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a long-term evolution (LTE) system, the frequency of any specific frequency band for a 5G next generation (NR) system, the frequency of any specific frequency band for a WiFi system, or the frequency of any specific frequency band for a Bluetooth (BT) system, etc.

The processing device 120 may be configured to handle corresponding communication protocol operations and processing the signals received from or to be transmitted to the radio transceiver 110. The application processing device 130 is configured to run the operating system of the communication apparatus 100 and to run application programs installed in the communication apparatus 100. The processing device 120 and the application processing device 130 can be realized by means of hardware (circuitry), software, firmware (known as a combination of a hardware device and computer instructions and data that reside as read-only software on the hardware device), an electronic system, or combination thereof. In the embodiments of the invention, the processing device 120 and the application processing device 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a subscriber identity module (SIM), universal mobile telecommunication system (UMTS) SIM (USIM), removable user identity module (R-UIM) or code division multiple access (CDMA) SIM (CSIM) card, or the like and may typically contain user account information, an International Mobile Subscriber Identity (IMSI) and a set of SIM application toolkit (SAT) commands and may provide storage space for phone book contacts. The memory device 150 may be coupled to the processing device 120 and the application processing device 130 and may store system data or user data.

It should be noted that, in order to clarify the concept of the invention, FIG. 1 presents a simplified block diagram in which only the elements relevant to the invention are shown. For example, in some embodiments of the invention, the communication apparatus 100 may further comprise some peripheral devices not shown in FIG. 1. In another example, in some embodiments of the invention, the communication apparatus 100 may further comprise a central controller coupled to the processing device 120 and the application processing device 130. Therefore, the invention should not be limited to what is shown in FIG. 1.

In some embodiments of the invention, the communication apparatus 100 is capable of supporting multiple radio access technologies (RATs) communications via the single-card structure as shown in FIG. 1. It should be noted that, although FIG. 1 shows a single-card application, the invention should not be limited herein. For example, in some embodiments of the invention, the communication apparatus 100 may comprise multiple subscriber identity cards to support the multi-RATS communications, in either a single-standby or a multiple-standby manner. In the multi-RATS communication applications, the modem, the radio transceiver and/or the antenna module may be shared by the subscriber identity card(s) and may have the capability of handling the operations of different RATS and processing the corresponding RF, IF or baseband signals in compliance with the corresponding communication protocols.

In addition, those who are skilled in this technology can still make various alterations and modifications based on the descriptions given above to derive the communication apparatuses comprising multiple radio transceivers and/or multiple antenna modules for supporting multi-RAT wireless communications without departing from the scope and spirit of this invention. Therefore, in some embodiments of the invention, the communication apparatus 100 may be designed to support a multi-card application, in either a single-standby or a multiple-standby manner, by making some alterations and modifications.

It should be further noted that the subscriber identity card 140 may be dedicated hardware cards as described above, or in some embodiments of the invention, there may be virtual cards, such as individual identifiers, numbers, addresses, or the like which are burned in the internal memory device of the corresponding modem and are capable of identifying the communication apparatus 100. Therefore, the invention should not be limited to what is shown in FIG. 1.

It should be further noted that in some embodiments of the invention, the communication apparatus 100 may further support multiple IMSIs.

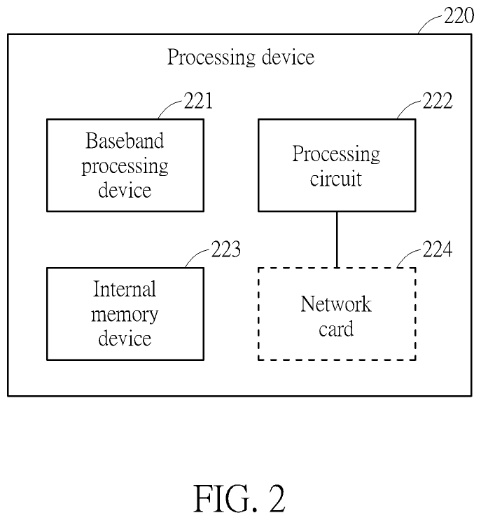

FIG. 2 is an exemplary block diagram of a processing device 220 according to an embodiment of the invention. The processing device 220 may be the processing device 120 shown in FIG. 1, and may comprise at least a baseband processing device 221, a processing circuit 222, an internal memory device 223 and a network card 224. The baseband processing device 221, the processing circuit 222, the internal memory device 223 and the network card 224 can be realized by means of hardware (circuitry), software, firmware, an electronic system, or combination thereof. The baseband processing device 221 may receive the IF or baseband signals from the radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware circuits to perform signal processing, such as an analog-to-digital converter for ADC conversion, a digital-to-analog converter for DAC conversion, an amplifier for gain adjustment, a modulator for signal modulation, a demodulator for signal demodulation, an encoder for signal encoding, a decoder for signal decoding, and so on.

According to an embodiment of the invention, the baseband processing device 221 may be designed to have the capability of handling the baseband signal processing operations for different RATs and processing the corresponding IF or baseband signals in compliance with the corresponding communications protocols, so as to support the multi-RAT wireless communications. According to another embodiment of the invention, the baseband processing device 221 may comprise a plurality of sub-units, each being designed to have the capability of handling the baseband signal processing operations of one or more specific RATs and processing the corresponding IF or baseband signals in compliance with the corresponding communications protocols, so as to support the multi-RAT wireless communications. Therefore, the invention should not be limited to any specific way of implementation.

The processing circuit 222 may control the operations of the processing device 220. According to an embodiment of the invention, the processing circuit 222 may be a processor arranged to execute the program codes of the processing device 220. For example, the processing circuit 222 may maintain and execute the individual tasks, threads, and/or protocol stacks for different software modules. A protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

In some embodiments of the invention, the processing circuit 222 may be pure hardware dedicated to dealing with the proposed method for handling a measurement configuration. This alternative design also falls within the scope of the present invention.

The processing circuit 222 may also read data from the subscriber identity card coupled to the processing device (e.g., the subscriber identity card 140 in FIG. 1), and write data to the subscriber identity card. The internal memory device 223 may store system data and user data for the processing device 220. The processing circuit 222 may also access the internal memory device 223.

The network card 224 provides Internet access services for the communication apparatus 100. It should be noted that, although the network card 224 shown in FIG. 2 is configured inside of the processing device 220, the invention should not be limited thereto. In some embodiments of the invention, the communication apparatus 100 may also comprise a network card configured outside of the processing device, or the communication apparatus 100 may also be coupled to an external network card for providing Internet access services. In some embodiments of the invention, the network card 224 may be a virtual network card, instead of a tangible card, that is created by the operating system of the communication apparatus 100. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be further noted that in some embodiments of the invention, the processing device 220 may also comprise more than one processing circuit and/or more than one baseband processing device. For example, the processing device 220 may comprise multiple processing circuits and/or multiple baseband processing devices for supporting multi-RAT operations. Therefore, the invention should not be limited to what is shown in FIG. 2.

It should be further noted that in some embodiments of the invention, the baseband processing device 221 and the processing circuit 222 may be integrated into one processing unit, and the processing device may comprise one or multiple such processing units, for supporting multi-RAT operations. Therefore, the invention should not be limited to what is shown in FIG. 2.

According to an embodiment of the invention, the processing circuit 222 and the application processing device 130 may comprise a plurality of logics designed for handling one or more functionalities. The logics may be configured to execute the program codes of one or more software and/or firmware modules, thereby performing the corresponding operations. When performing the corresponding operations by executing the corresponding programs, the logics may be regarded as dedicated hardware devices or circuits, such as dedicated processor sub-units. Generally, the processing circuit 222 may be configured to perform operations of relative lower protocol layers while the application processing device 130 may be configured to perform operations of relative higher protocol layers. Therefore, in some embodiments of the invention, the application processing device 130 may be regarded as the upper layer entity or upper layer processing circuit with respect to the processing circuit 222 and the processing circuit 222 may be regarded as the lower layer entity or lower layer processing circuit with respect to the application processing device 130.

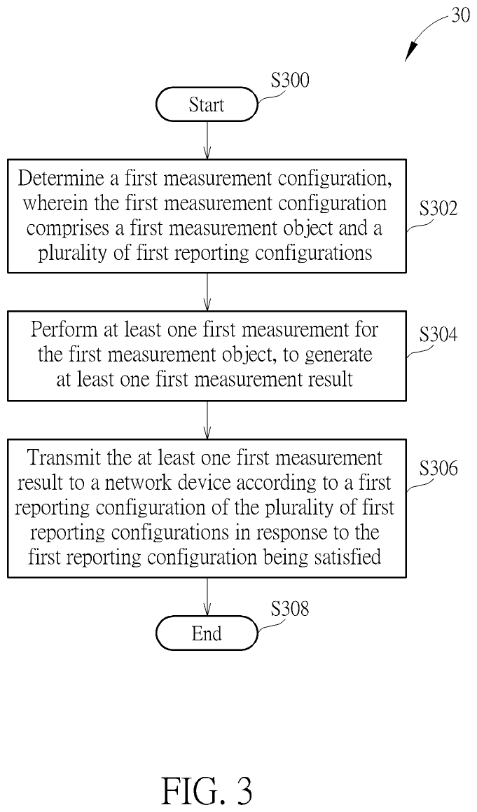

FIG. 3 is a flowchart of a process 30 utilized in a first communication apparatus (e.g., the communication apparatus 100 shown in FIG. 1) according to an embodiment of the invention, to handle a measurement configuration. Provided that the result is substantially the same, the steps are not required to be executed in the exact order shown in FIG. 3. The process 30 comprises the following steps:

Step S300: Start.

Step S302: Determine a first measurement configuration, wherein the first measurement configuration comprises a first measurement object and a plurality of first reporting configurations.

Step S304: Perform at least one first measurement for the first measurement object, to generate at least one first measurement result.

Step S306: Transmit the at least one first measurement result to a network device according to a first reporting configuration of the plurality of first reporting configurations in response to the first reporting configuration being satisfied.

Step S308: End.

The processing circuit 222 is configured to perform steps of the process 30. According to the process 30, the first communication apparatus determines (e.g., sets or is configured with) a first measurement configuration. The first measurement configuration comprises a first measurement object and a plurality of first reporting configurations. The plurality of first reporting configurations correspond to (e.g., are linked to) the first measurement object. Then, the first communication apparatus performs at least one first measurement for the first measurement object, to generate at least one first measurement result. The first communication apparatus transmits (e.g., reports) the at least one first measurement result to a network device according to a first reporting configuration of the plurality of first reporting configurations in response to the first reporting configuration being satisfied. Thus, the plurality of first reporting configurations are applied flexibly, and the performances of performing the at least one first measurement and transmitting the at least one first measurement result can be improved.

Realization of the process 30 is not limited to the above description. The following embodiments of the invention may be applied to realize the process 30.

There are various ways to determine the first measurement configuration. In an embodiment of the invention, the first communication apparatus may receive the first measurement configuration from the network device. That is, the first communication apparatus is configured with the first measurement configuration by the network device. In this case, the first measurement configuration comprising the plurality of the reporting configurations is configured by the network device. Each of the plurality of reporting configurations is configured to at least one particular communication apparatus with a specific condition. In an embodiment of the invention, the first communication apparatus may set the first measurement configuration according to a design algorithm. That is, the first communication apparatus configures the first measurement configuration by itself.

In an embodiment of the invention, a second communication apparatus determines a second measurement configuration. The second measurement configuration comprises a second measurement object and a plurality of second reporting configuration. The plurality of second reporting configurations correspond to (e.g., are linked to) the second measurement object. Then, the second communication apparatus performs at least one second measurement for the second measurement object, to generate at least one second measurement result. The second communication apparatus transmits the at least one second measurement result to the network device according to a second reporting configuration of the plurality of second reporting configurations in response to the second reporting configuration being satisfied. That is, the first communication apparatus and the second communication apparatus under different conditions (e.g., in different environments) may perform the measurements and transmit the measurement results according to different reporting configurations with different parameters. It should be noted that, there are two communication apparatuses (e.g., the first communication apparatus and the second communication apparatus) in the present embodiment, but not limited herein. The number of communication apparatuses may be two or more than two.

By way of example, but not limitation, each of the first communication apparatus and the second communication apparatus may be implemented using the same hardware architecture such as that of the communication apparatus 100 shown in FIG. 1, and the same process 30 may also be utilized in the second communication apparatus.

There are various ways to determine the second measurement configuration of the plurality of measurement configurations. In an embodiment of the invention, the second communication apparatus may receive the second measurement configuration from the network device. In this case, the first measurement configuration and the second measurement configuration are the same measurement configuration. That is, the network device configures the same measurement configuration to all communication apparatuses. In an embodiment of the invention, the second communication apparatus may set the second measurement configuration according to the design algorithm. In this case, the first measurement configuration and the second measurement configuration are the same measurement configuration or different measurement configurations. The detail of determining the second measurement configuration may be referred to the above embodiments of determining the first measurement configuration, and is not narrated herein for brevity.

In an embodiment of the invention, the plurality of first reporting configurations comprise a plurality of first time durations (e.g., time-to-trigger (TTT)) and a plurality of first measurement thresholds, respectively. A time duration (e.g., one of the plurality of first time durations) guarantees that a ping-pong effect can be eliminated by specifying a time window in which an entering condition for a measurement event occurs to transmit the measurement result to the network device. A measurement threshold (e.g., one of the plurality of first measurement thresholds) is a threshold parameter for a measurement event. In an embodiment of the invention, the plurality of first time durations have (e.g, are) different values. In an embodiment of the invention, the plurality of first measurement thresholds have (e.g, are) different values.

In an embodiment of the invention, one of the plurality of first reporting configurations comprises a time duration with the greatest value among the plurality of first time durations, and comprises a measurement threshold with the smallest value among the plurality of first measurement thresholds. In an embodiment of the invention, one of the plurality of first reporting configurations comprises a time duration with the smallest value among the plurality of first time durations, and comprises a measurement threshold with the greatest value among the plurality of first measurement thresholds. In an embodiment of the invention, one of the plurality of first reporting configurations comprises a time duration with the second greatest value among the plurality of first time durations, and comprises a measurement threshold with the second smallest value among the plurality of first measurement thresholds. The relationship between the time duration and the measurement threshold in one of the plurality of first reporting configurations is analogous, and is not narrated herein for brevity.

In an embodiment of the invention, the plurality of first reporting configurations comprise a plurality of first measurement hystereses, respectively. A measurement hysteresis (e.g., one of the plurality of first measurement hystereses) is a hysteresis parameter for a measurement event.

In an embodiment of the invention, the plurality of second reporting configurations comprise a plurality of second time durations (e.g., time-to-trigger (TTT)) and a plurality of second measurement thresholds, respectively. In an embodiment of the invention, the plurality of second reporting configurations comprise a plurality of second measurement hystereses, respectively. The plurality of second time durations, the plurality of second measurement thresholds, the plurality of second measurement hystereses and a relationship between a time duration and a measurement threshold in one of the plurality of second reporting configurations may be referred to the above embodiments of the plurality of first time durations, the plurality of first measurement thresholds, the plurality of first measurement hystereses and the relationship between the time duration and the measurement threshold in one of the plurality of first reporting configurations, and are not narrated herein for brevity.

In an embodiment of the invention, an entering condition and a leaving condition for a measurement event are predefined by, for example, the 3rd Generation Partnership Project (3GPP) standard. The measurement event may be one of the measurement events A1-A6 and B1-B2, but not limited herein. Taking the measurement event A1 as an example, the entering condition is Ms−Hys>Thresh, and the leaving condition is Ms+Hys<Thresh. Ms is the measurement result of a serving cell without taking any offsets into account. Hys is a measurement hysteresis (e.g., one of the plurality of first measurement hystereses or one of the plurality of second measurement hystereses) for the measurement event A1. Thresh is a measurement threshold (e.g., one of the plurality of first measurement thresholds or one of the plurality of second measurement thresholds) for the measurement event A1.

In an embodiment of the invention, the first reporting configuration is satisfied (in Step S306) means (e.g., represents) that the entering condition applied according to a hysteresis and a measurement threshold in the first reporting configuration is satisfied and that the leaving condition applied according to the hysteresis and the measurement threshold in the first reporting configuration is not satisfied. In an embodiment of the invention, the second reporting configuration is satisfied means that the entering condition applied according to a hysteresis and a measurement threshold in the second reporting configuration is satisfied and that the leaving condition applied according to the hysteresis and the measurement threshold in the second reporting configuration is not satisfied. That is, the first/second communication apparatus determines that the first/second reporting configuration is satisfied in response to the satisfied entering condition and the unsatisfied leaving condition.

In an embodiment of the invention, a measurement object (e.g., the first measurement object or the second measurement object) indicates (e.g., specifies) a synchronization signal block (SSB) or a channel state information reference signal (CSI-RS) to be measured, and further comprises (e.g., specifies) related auxiliary information for the measurement. The first measurement object and the second measurement object may be the same measurement object or different measurement objects.

In an embodiment of the invention, the first measurement configuration comprises a plurality of first measurement identities, and the second measurement configuration comprises a plurality of second measurement identities. In an embodiment of the invention, the plurality of first measurement identities indicate that the plurality of first reporting configurations correspond to the first measurement object, respectively. In an embodiment of the invention, the plurality of second measurement identities indicate that the plurality of second reporting configurations correspond to the second measurement object, respectively. That is, one reporting configuration may correspond to one measurement object, while one measurement object may correspond to one or more reporting configurations.

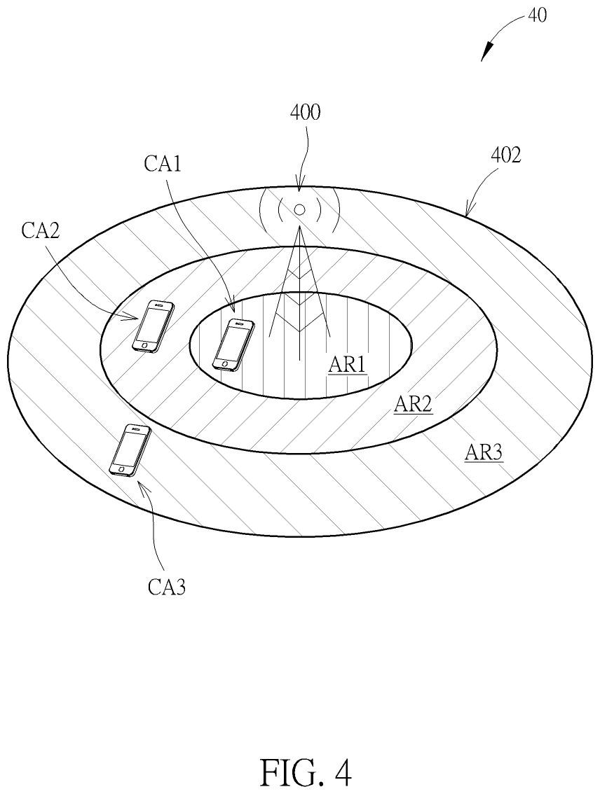

FIG. 4 is a schematic diagram of a scenario 40 according to an embodiment of the invention. There is a next generation Node-B (gNB) 400 (e.g., the network device in the process 30) in the present embodiment. A coverage area 402 of the gNB 400 is divided into areas AR1-AR3. The gNB 400 configures reporting configurations RpConfig1-RpConfig3 to communication apparatuses CA1-CA3. The reporting configurations RpConfig1-RpConfig3 correspond to the same measurement object, and comprise time durations TTT1-TTT3 (e.g., TTT1<TTT2<TTT3) and measurement thresholds Thresh1-Thresh3 (e.g., Thresh1>Thresh2>Thresh3), respectively.

In FIG. 4, the communication apparatus CA1 in the area AR1 with a high measurement result applies the reporting configuration RpConfig1 with the short time duration TTT1 to transmit the high measurement result to the gNB 400. The communication apparatus CA2 in the area AR2 with a moderate measurement result applies the reporting configuration RpConfig2 and waits for the moderate time duration TTT2, to transmit the moderate measurement result to the gNB 400. The communication apparatus CA3 in the area AR3 with a small measurement result applies the reporting configuration RpConfig3 and waits for the long time duration TTT3, to transmit the small measurement result to the gNB 400. The communication apparatuses CA1-CA3 in different areas AR1-AR3 are configured with the same reporting configurations by the gNB 400, but apply different reporting configurations to ensure a stable connection quality. The performances of performing the measurements and transmitting the measurement results can be improved.

In other embodiment of the invention, the communication apparatuses CA1-CA3 set the reporting configurations RpConfig1-RpConfig3 by themselves, instead of receiving the reporting configurations RpConfig1-RpConfig3 from the gNB 400 that configures the reporting configurations RpConfig1-RpConfig3 to the communication apparatuses CA1-CA3.

To sum up, the present invention provides a communication apparatus and a method for handling a measurement configuration. The communication apparatuses under different conditions perform measurements and transmit measurement results according to different reporting configurations with different parameters. Therefore, the communication apparatus with a proper reporting configuration may improve the performances of performing the measurement and transmitting the measurement result.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling a measurement configuration, comprising:
determining a measurement configuration, wherein the measurement configuration comprises a measurement object and a plurality of reporting configurations;
performing at least one measurement for the measurement object, to generate at least one measurement result; and
transmitting the at least one measurement result to a network device according to a reporting configuration of the plurality of reporting configurations in response to the reporting configuration being satisfied;
wherein the plurality of reporting configurations correspond to the measurement object.

2. The method of claim 1, wherein the step of determining the measurement configuration comprises:
receiving the measurement configuration from the network device.

3. The method of claim 1, wherein the step of determining the measurement configuration comprises:
setting the measurement configuration according to a design algorithm.

4. The method of claim 1, wherein the plurality of reporting configurations comprise a plurality of time durations and a plurality of measurement thresholds, respectively.

5. The method of claim 4, wherein one of the plurality of reporting configurations comprises a time duration with the greatest value among the plurality of time durations, and comprises a measurement threshold with the smallest value among the plurality of measurement thresholds.

6. The method of claim 4, wherein one of the plurality of reporting configurations comprises a time duration with the smallest value among the plurality of time durations, and comprises a measurement threshold with the greatest value among the plurality of measurement thresholds.

7. The method of claim 1, wherein the plurality of reporting configurations comprise a plurality of measurement hystereses, respectively.

8. The method of claim 1, wherein the reporting configuration is satisfied means that a entering condition for a measurement event applied according to a hysteresis and a measurement threshold in the reporting configuration is satisfied and that the leaving condition for the measurement event applied according to the hysteresis and the measurement threshold in the reporting configuration is not satisfied.

9. The method of claim 1, wherein the measurement configuration comprises a plurality of measurement identities.

10. The method of claim 9, wherein the plurality of measurement identities indicate that the plurality of reporting configurations correspond to the measurement object, respectively.

11. A communication apparatus, comprising:
a radio transceiver, configured to transmit or receive wireless signals; and
a processing circuit, coupled to the radio transceiver and configured to perform operations comprising:
determining a measurement configuration, wherein the measurement configuration comprises a measurement object and a plurality of reporting configurations;
performing at least one measurement for the measurement object, to generate at least one measurement result; and
transmitting the at least one measurement result to a network device according to a reporting configuration of the plurality of reporting configurations in response to the reporting configuration being satisfied;
wherein the plurality of reporting configurations correspond to the measurement object.

12. The communication apparatus of claim 11, wherein the communication apparatus determines the measurement configuration by receiving the measurement configuration from the network device.

13. The communication apparatus of claim 11, wherein the communication apparatus determines the measurement configuration by setting the measurement configuration according to a design algorithm.

14. The communication apparatus of claim 11, wherein the plurality of reporting configurations comprise a plurality of time durations and a plurality of measurement thresholds, respectively.

15. The communication apparatus of claim 14, wherein one of the plurality of reporting configurations comprises a time duration with the greatest value among the plurality of time durations, and comprises a measurement threshold with the smallest value among the plurality of measurement thresholds.

16. The communication apparatus of claim 14, wherein one of the plurality of reporting configurations comprises a time duration with the smallest value among the plurality of time durations, and comprises a measurement threshold with the greatest value among the plurality of measurement thresholds.

17. The communication apparatus of claim 11, wherein the plurality of reporting configurations comprise a plurality of measurement hystereses, respectively.

18. The communication apparatus of claim 11, wherein the reporting configuration is satisfied means that a entering condition for a measurement event applied according to a hysteresis and a measurement threshold in the reporting configuration is satisfied and that the leaving condition for the measurement event applied according to the hysteresis and the measurement threshold in the reporting configuration is not satisfied.

19. The communication apparatus of claim 11, wherein the measurement configuration comprises a plurality of measurement identities.

20. The communication apparatus of claim 19, wherein the plurality of measurement identities indicate that the plurality of reporting configurations correspond to the measurement object, respectively.
